(19) United States
(12) Patent Application Publication
(10) Pub. No.: US 2004/0125732 A1
(43) Pub. Date: Jul. 1, 2004

(54) Data recording method of optical storage medium

(76) Inventors: Yuh Cheng, Hsinchu (TW); Pi-Hai Liu, Hsinchu (TW); Chang-Po Ma, Hsinchu (TW)

Correspondence Address: BIRCH STEWART KOLASCH & BIRCH, PO BOX 747, FALLS CHURCH, VA, 22040-0747, US

(21) Appl. No.: 10/428,850

(22) Filed: May 5, 2003

(30) Foreign Application Priority Data
Dec. 30, 2002 (TW) 091137906

(51) Int. Cl. G11B 7/0045

(52) U.S. Cl. 369/59.27; 369/95

(57) ABSTRACT

A data recording method of optical storage medium is disclosed. The method employs the orthogonal frequency division multiplexing (OFDM) to record the data in order to increase the usage efficiency of the storage channel. The method evolves dividing a storage channel into multiple sub-channels, and then determining the recordable bits of the multiple sub-channels according to the signal to noise ratio of the storage channel; next, an input signal to be recorded on the optical storage medium is transformed from frequency domain to time domain such that a time-domain signal is obtained; at last, recording the time-domain signal on the optical storage medium through a compositive modulation of pulse width and pulse amplitude.

### BACKGROUND OF THE INVENTION

1. Field of the Invention

The invention generally relates to a data recording method of optical storage medium, and particularly relates to a data recording method of optical storage medium in which an orthogonal frequency division multiplexing (OFDM) process is applied.

2. Related Art

To increase the storage capacity is a very important issue for a data storage medium. For example, in an optical disc system, in order to increase the storage capacity, a HD DVD specification, proposed by the DVD Forum, is achieved by change of wavelength of laser beam and NA value of the lens so as to narrow the light spot, narrow the pits on the disc and increase the data storage capacity. Besides that, Calimatric Company invents a multiple layer recording method for replacing conventional binary recording and also increasing the data storage capacity.

A conventional binary recording manner is shown in FIG. 1. The data recorded on an optical storage medium is in a form of pits and lands. The circular or elliptic shaded portions in the drawing represent the pits. The pits and the lands give different reflectivity to the scanning laser spot as shown in the drawing. When the storage medium rotates, the pits and lands pass over the laser spot, an optical detector produces radio frequency (RF) signals based on the reflection beam. The RF signals are convolution (I*R) of the spot irradiance I and the reflectance R. The RF signals are parsed by a parser into EFM signals, which are further transformed into digital binary signals through timing recovery. The conventional recording method cannot increase storage capacity. Therefore, a multiple level recording method has been developed.

The multiple level data recording method is shown in FIG. 2. The central positions of the pits are in a same interval, which is the time unit. Different sizes of pits produce different reflectivity for the laser spot. The different reflection magnitude represents the signal level. In order to get multiple levels, the write strategy includes both pulse width modulation (PWM) and pulse amplitude modulation (PAM).

No matter a binary recording or a multiple-level recording is used, the data recorded on a recording medium is based on time domain. However, when considering the signal to noise ratio in the storage channel, we can find another way to improve the data recording as described below.

FIG. 7 is a channel response diagram of a general optical disc system. The rigid line represents the channel response. The other dot lines are input signal response, white noise response, medium noise response and sever noise respectively. By summating the aforesaid signals, a signal to noise ratio (SNR) curve, as shown in FIG. 8, is obtained.

The SNR curve shows that in the lower frequency region, since the servo noise is higher, the SNR is lower; in the medium frequency region, since the noise is lower, the SNR is higher; and in the high frequency region, since the signal power is decreased through the channel, the SNR is comparatively lower too. So, we can find from the curve that the SNR is best in the middle portion. However, conventional recording method did not take advantage of this. It neglected the SNR difference so that signals in the higher or lower frequency region were difficult or failed to be retrieved, and the storage capacity were limited.

### SUMMARY OF THE INVENTION

In order to solve the aforesaid problems, the invention provides a data recording method of optical storage medium in which an orthogonal frequency division multiplexing (OFDM) process is applied. The OFDM is incorporated with signal to noise ratio of the channel response so that the SNR characteristics are well utilized for enhancing the data storage efficiency.

The data recording method according to the invention utilizes the signal to noise ratio characteristics of the storage channel. That is, to store more data in the higher SNR region and to store less data in the lower SNR region so as to increase the total data storage capacity on a same bit error rate.

The invention uses an orthogonal frequency division multiplexing process and accommodates to signal to noise ratio characteristics of the storage channel. The storage channel is therefore efficiently used for a higher storage capacity. The orthogonal frequency division multiplexing is based on channel partition that the whole wide-band channel is divided into several individual narrow-band sub-channels. The orthogonal frequency division multiplexing uses a set of multiple N-channel vector-base carrier waves to carry the recorded data with their coefficients. The base and the coefficients compose specific signals to be recorded on the data storage medium. By arranging the coefficient bits, the usage efficiency of the storage channel is improved, and a highly efficient OFDM data storage method is obtained.

An OFDM process arranges data in a frequency domain. In order to prevent the time domain signal from being a complex number, the data is arranged in a conjugated and symmetric manner in the frequency domain. Because a multiple level signal in time domain cannot be handled with conventional binary recording method, the recording method of the invention utilizes compositive pulse width modulation (PWM) and pulse amplitude modulation (PAM) to record the data.

In order to achieve the aforesaid objective, the method of the invention includes steps of dividing a storage channel into multiple sub-channels, and then determining the recordable bits of the multiple sub-channels according to the signal to noise ratio of the storage channel; next, an input signal to be recorded on the optical storage medium is transformed from frequency domain to time domain such that a time-domain signal is obtained; at last, recording the time-domain signal on the optical storage medium through a compositive modulation of pulse width and pulse amplitude.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is an explanatory view of a conventional binary data recording method;

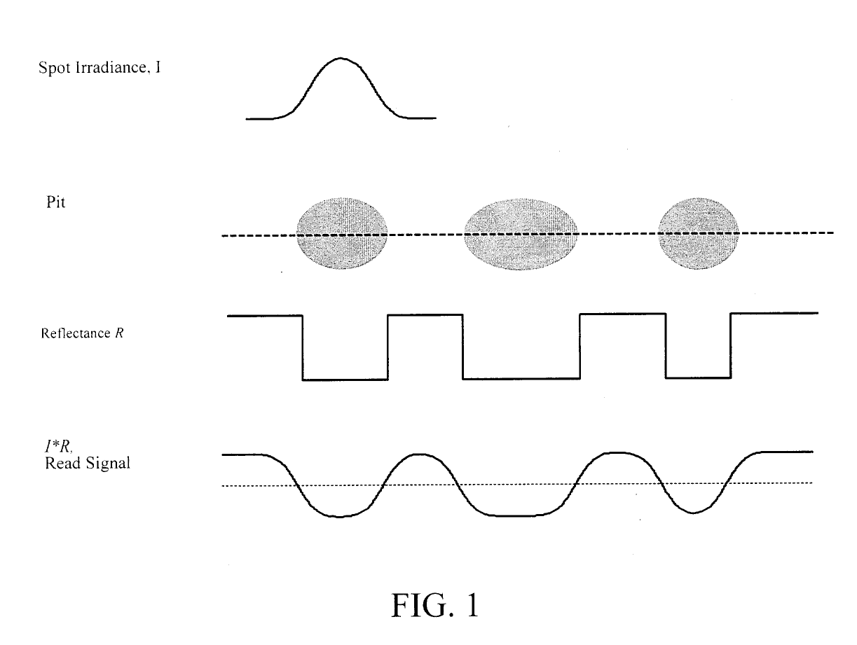

FIG. 2 is an explanatory view of a multiple level data recording method;

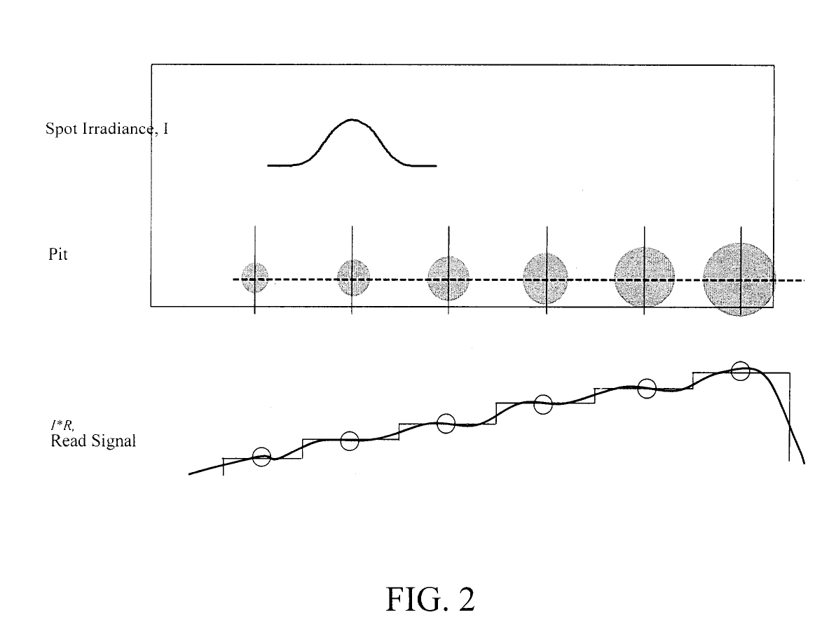

FIG. 3 is a block diagram showing a data recording and retrieving process through orthogonal frequency division multiplexing according to the invention;

FIG. 4 is an explanatory view of a sub-channel applied in orthogonal frequency division multiplexing of the invention;

FIG. 5 is an explanatory view of a data storage method for writing signal xₖ in each time section according to the invention;

FIG. 6 is an explanatory view showing the compositive PWM and PAM modulation according to the invention;

FIG. 7 is a channel response diagram of a general optical disc system;

FIG. 8 is a signal to noise ratio (SNR) curve of a data storage channel;

FIG. 9 is a frequency response chart of a data storage channel; and

FIG. 10 is a signal performance diagram of data storage through OFDM of the invention and comparing to conventional binary recording.

### DETAILED DESCRIPTION OF THE INVENTION

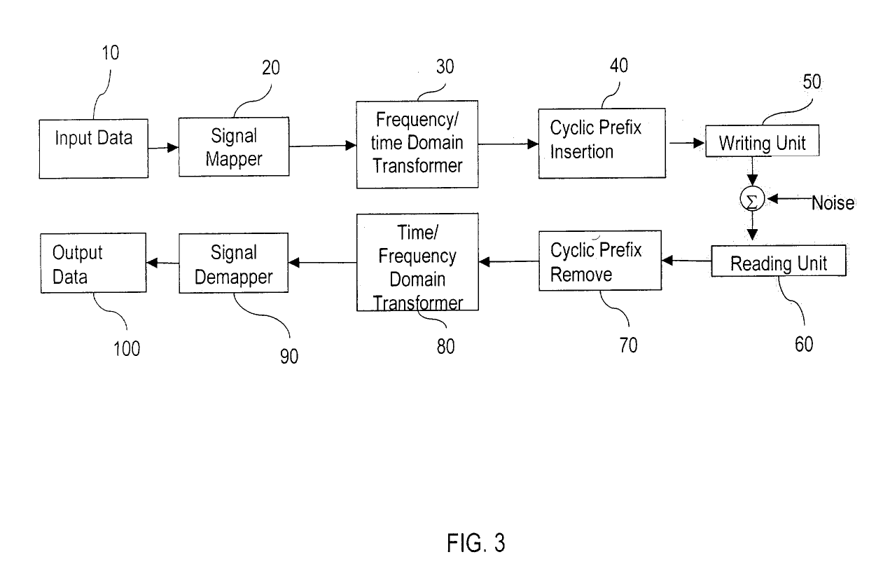

Now referring to FIG. 3, a data recording and retrieving process through orthogonal frequency division multiplexing method according to the invention is illustrated. In the data recording process, the input data 10 is the data to be recorded on the optical storage medium. A signal mapper 20 arranges each sub-channel with suitable recorded bits according to the signal to noise ratio of the storage channel. The data is presented as a specific complex number and arranged in the channels in a conjugated and symmetric manner. This is the input signal, described hereinafter as input signal X, of the orthogonal frequency division multiplexing writing signal. A frequency/time domain transformer 30 transforms the input signal X of frequency domain into time domain signal through inverse discrete Fourier transform (IDFT). A cyclic prefix insertion (CPI) 40 copies a rear wave portion of the time domain signal frame as a prefix signal of a next signal frame so as to form a new time domain signal x. The cyclic prefix inserted in the signal frame is a writing signal of the optical storage medium. The cyclic prefix insertion 40 makes the system easier for channel partition.

Then, a writing unit 50 writes the time domain signal x to the optical storage medium in a specific manner.

The data stored on the storage medium is retrieved by a reading unit 60. The reading unit 60 gets retrieved data signal from the optical storage channel. An analog to digital converter converts the retrieved analog signal into digital signal y. A cyclic prefix remove (CPR) 70 removes the inserted cyclic prefix. A time/frequency domain transformer 80 transforms the time domain signal y into frequency domain signal Y through discrete Fourier transform (DFT). Finally, a signal demapper 90 retrieves the original data as an output data 100 from the signal Y.

The detailed operation of the orthogonal frequency division multiplexing is described below. The storage channel of the optical storage medium is taken as a linear channel whose response can be simply described with a discrete time finite impulse response (FIR) filter. The discrete time pulse response of the storage channel is described as h=[₀ . . . hᵥ]. The input signal x for the storage medium is x=[c₋ᵥ . . . x₋₁x₋₀ . . . x_{N-1}]^{T}. The retrieved signal y is y=[y₀ . . . y_{N-1}]^{T}. The channel noise is n=[n₀ . . . n_{N-1}]^{T}. The orthogonal frequency division multiplexing, is a general channel partition method. By incorporating a cyclic prefix insertion in the transmission sequence, the difficulty of channel partition is further decreased.

Let x₋ₖ=X_{N-k}, k=1, . . . , v, the cyclic prefix insertion (CPI) copies the rear portion of the transmission signal and inserts it in front of the next transmission vector. The CPI transmission is described as:

$$[ \begin{matrix}{y}_{N - 1} \\ ⋮ \\ {y}_{0}\end{matrix} ] = [ \begin{matrix}{h}_{0} & {h}_{1} & … & {h}_{v} & 0 & 0 & … & 0 \\ 0 & {h}_{0} & {h}_{1} & … & {h}_{v} & 0 & … & 0 \\ ⋮ & & ⋰ & & ⋰ & & ⋰ & ⋮ \\ 0 & 0 & … & 0 & {h}_{0} & {h}_{1} & … & {h}_{v} \\ {h}_{v} & 0 & … & & 0 & {h}_{0} & … & {h}_{v - 1} \\ ⋮ & & ⋰ & & ⋰ & & ⋰ & ⋮ \\ {h}_{1} & & … & {h}_{v} & 0 & … & 0 & {h}_{0}\end{matrix} ] [ \begin{matrix}{x}_{N - 1} \\ ⋮ \\ {x}_{0}\end{matrix} ] + [ \begin{matrix}{n}_{N - 1} \\ ⋮ \\ {n}_{0}\end{matrix} ]$$

or y=H\hat{x}+n in which

\hat{x}=[x₀ . . . x_{N-1}]^{T}; H is a circular matrix.

The CPI makes the orthogonal frequency division multiplexing system easier in channel partition calculation.

Suppose a signal vector is w=[w₀ . . . w_{N-1}]^{T}. By operating a DFT to the signal to get a W signal W=[W₀ . . . W_{N-1}]^{T}. The elements of the signal W can be described as:

$${W}_{k} = \frac{1}{\sqrt{N}} {\sum }_{n = 0}^{N - 1} {w}_{n} {ⅇ}^{- j \frac{2 π}{N} k n} , k = 0 , … , N - 1.$$

In reverse, operating an IDF-T to the W signal can get the w signal. The elements of the

$${w}_{k} = \frac{1}{\sqrt{N}} {\sum }_{n = 0}^{N - 1} {W}_{n} {ⅇ}^{j \frac{2 π}{N} kn} , k = 0 , … , N - 1.$$

The DFT and IDFT can be described with a matrix:

$$\begin{matrix}W = Qw \\ w = {Q}^{*} W ,\end{matrix}$$

in which Q is the orthogonal matrix of DFT, and Q* is the orthonormal matrix of IDFT. The elements of Q are

$${q}_{k , n} = \frac{1}{\sqrt{N}} {ⅇ}^{- j \frac{2 π}{N} kn} .$$

The circular matrix H includes even-decomposition: H=Q*ΛQ, in which Λ is a diagonal matrix. Values on the diagonal line are λₖk=0,1, . . . , N−1, and y=Q*ΛQ+n.

As shown in FIG. 3, suppose the input signal of the orthogonal frequency division multiplexing system is a frequency domain signal X. The orthogonal frequency division multiplexing is to operate an IDFT to the signal X and get a time domain signal x, which is the writing signal x, x=Q*X

The orthogonal frequency division multiplexing further operates a DFT to the retrieved (read back) time domain signal y and gets a frequency domain output signal Y, Y=Qy.

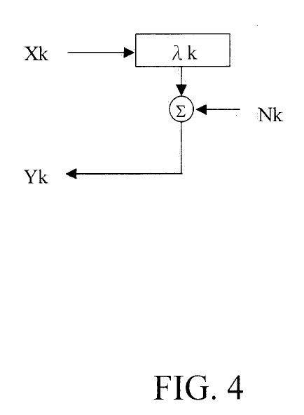

The above formulas can be rearranged as Y=ΛX+N, in which N=Qn If n is an independent Gaussian white noise, then N is an independent Gaussian white noise also. Since Λ is a diagonal matrix, and λₖ are values on the diagonal line, the above formula can be described with N numbers of independent sub-channels Yₖ=λₖXₖ+Nₖ, k=0, . . . , N−1, in which λₖ is the number k sub-channel response in the frequency response transformed by DFT from the storage channel response h. From the above formula in frequency domain, the input signal Xₖ and the output signal Yₖ can be taken as a simple system, as shown in FIG. 4, which is also an explanatory view of sub-channels of the orthogonal frequency division multiplexing system. In which, λₖ is a transfer function of each sub-channel in the frequency domain that represents the size and phrase change between the signals Xₖ and Yₖ. And, Nₖ represents the noise of the data storage channel.

In order to increase storage capacity, the characteristics of signal to noise ratio of the storage channel have to be utilized and accompanied with an orthogonal frequency division multiplexing as described below.

In order to maximize the data storage capacity, the recordable bits of each sub-channel is suitably arranged in accordance with the signal to noise ratio of each sub-channel so as to optimize the performance of the whole channel.

According to Shannon's information theory, for a memoryless channel, regardless of complicity and limitation of decoding time, the maximum capacity C of a storage channel can be described as C=log₂(1+SNR) where the SNR is defined as

$$SNR = \frac{{ξ}_{Y}}{2 {σ}^{2}} ,$$

the ξᵥ=E{|Y|²} is the power of output signal, and the

$$2 {σ}^{2} = E \{ \vert {N}_{k}^{2} \vert \}$$

is the variance of Gaussian white noise.

In practice, when data transmitted through different coding scheme, under an error rate of Pₑ, the ratio difference between the SNR and an ideal SNR is called “SNR gap”: Γ(c, Pₑ) The affordable recorded bits for each sub-channel are

$${b}_{k} = {log}_{2} ( 1 + \frac{{SNR}_{k}}{Γ ( C , {P}_{e} )} ) ,$$

and the whole data storage capacity is

$$B = {\sum }_{k = 0}^{N - 1} {b}_{k} = {\sum }_{k = 0}^{N - 1} {log}_{2} ( 1 + \frac{{SNR}_{k}}{Γ ( C , {P}_{e} )} ) .$$

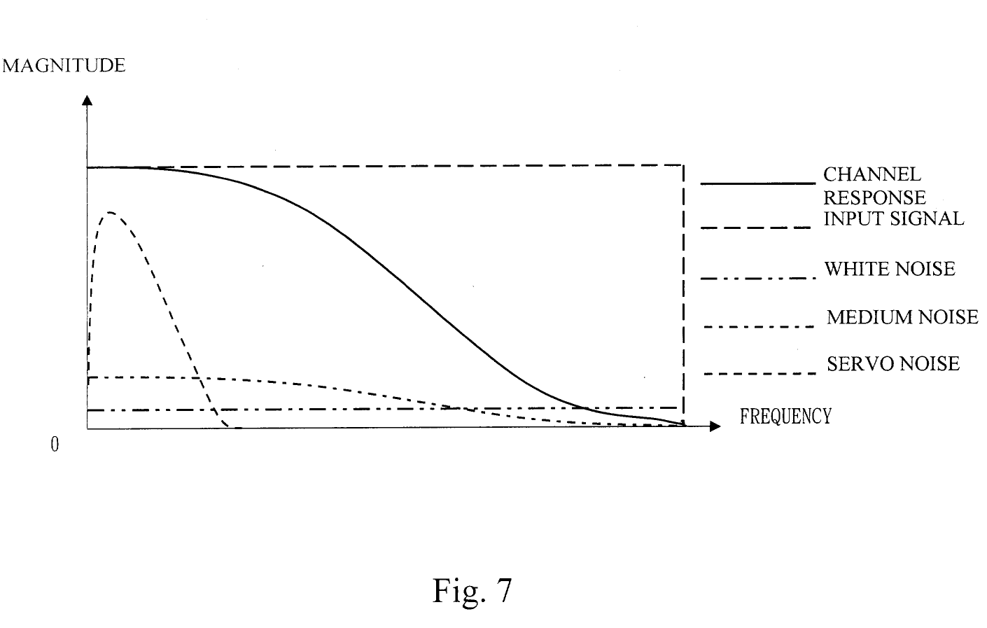

The optical data storage channel is similar to a low bandpass filter. Therefore, the lower frequency portion gets higher in the channel power transfer function curve, as shown in FIG. 7.

Through observing the input signals X of the orthogonal frequency division multiplexing system for a period of time, it is found that the power spectrum Sₓ=|X|² of the input signal X is correlative to the recordable bits determined by the signal transformer for each sub-channel.

The close loop transfer function T of the servo of the optical recording system is a low bandpass filter. The disturbed signal on the optical disc is mostly of lower frequency. The servo control error is eₛ=(T)d Since the servo noise of the servo signal is positively correlative to the sever control error eₛ, the power spectrum S_{SN} of servo noise is similar to the power spectrum of sever control error eₛ as shown in FIG. 7. The medium noise is caused by uneven reflectivity on the impurities on the disc or the variance during writing. When the medium noise is not passing the optical reading channel, the power spectrum S_{MN} of the medium noise is flat like the white noise. While, when signal is passing the reading channel, the spectrum of the medium noise has a similar shape to that of the channel transfer function. The power spectrum S_{EN} of electronic noise is similar to white noise and joins only when the data signal is passing the optical reading channel. Therefore, the power spectrum of electronic noise of the read signal is flat.

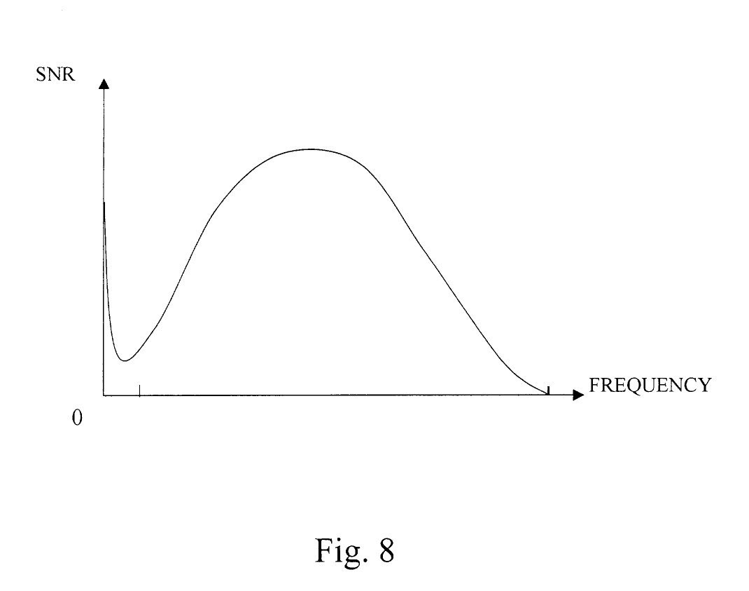

Because the dependency among the noises is low, the summation S_{TN} of the power spectrums of the noises can be described as S_{TN}=S_{SN}+S_{MN}+S_{FN}. The total signal to noise ratio can be described as

$$SNR = \frac{{\vert DFT ( h ) \vert}^{2} {S}_{X}}{{S}_{TN}} ,$$

in which S_{H}=|DFT(h)|² is a power transfer function of the optical storage channel. The curve of the total SNR is illustrated in FIG. 8.

If we arrange same bits to each sub-channel, then the signal quality at the lower SNR portion is poor and has a higher error rate. In order to maintain a same error rate for each sub-channel and maximize the data storage capacity, the recordable bits for each specific sub-channel can be set as:

$${b}_{k} = {log}_{2} ( 1 + \frac{{SNR}_{k}}{Γ ( C , {P}_{e} )} ) .$$

The following are two examples of arranging the recordable bits. In a first example, supposing the SNR of a number k sub-channel is SNRₖ=13 dB; a quadrature phase shift keying (QPSK) method is used for coding, and a bit error rate is requested of Pe<10⁻⁵, then, the SNR gap is Γ(C, Pe)=7.7 dB The maximum bit is calculated as

$${b}_{k} = {log}_{2} ( 1 + \frac{{10}^{\frac{13}{10}}}{{10}^{\frac{7.7}{10}}} ) = 2.13 .$$

By taking an integer, the sub-channel can hold 2 bits of data. This is an example of directly taking an integer for the recordable bit.

The second example is, when a signal to noise ratio is SNRₖ=11 dB, also using QPSK coding method, a maximum bit is calculated as

$${b}_{k} = {log}_{2} ( 1 + \frac{{10}^{\frac{11}{10}}}{{10}^{\frac{7.7}{10}}} ) = 1.65 .$$

The bit number is less than 2. However, if we incorporate an error correcting code (ECC) of ¾ coding rate, then a 2 bit data contains only

$$2 \times \frac{3}{4} = 1.5$$

bit information. Therefore, it still meets the error rate requirement of Pₑ=10⁻⁵.

The sub-channel recordable bits can be arranged like the aforesaid examples and by referring to FIG. 8. However, the frequency portion lower than f_{w} in the drawing will influence the servo control and cannot be used to carry data.

The input data are stored in the frequency domain with complex numbers. In order to make the retrieved data presented with real numbers when being transformed from frequency domain to time domain, the writing data is arranged in a conjugated and symmetric manner. Let data arranged in 2N sub-channels of frequency domain, totally

$$B = {\sum }_{k = 0}^{N - 1} {b}_{k}$$

bits of data are arranged in the number 0 to number (N−1) sub-channels with hₖ bits in each sub-channel. The input signals for each sub-channel are Xₖ, which are also symmetrically arranged in the number (N+1) to number (2N−1) sub-channels. In other words, Xₖ=X*_{2N-k}. Also, the input signal X_{N} in the number N sub-channel shall be a real number.

Signals in the time domain are of multiple levels. Therefore, a multiple level time domain signal recording method is required. A time unit (1T) period is first divided into multiple sections. The width of the section is determined by magnitude of the input signal so that a larger input signal uses a wider section, and a smaller input signal uses a shorter section. Therefore, the section width corresponds the magnitude of the writing signal. This is pulse width modulation. In order to increase the data resolution, two adjacent sections can be written with different amplitudes. This is an incorporation of pulse amplitude modulation and will be further described below.

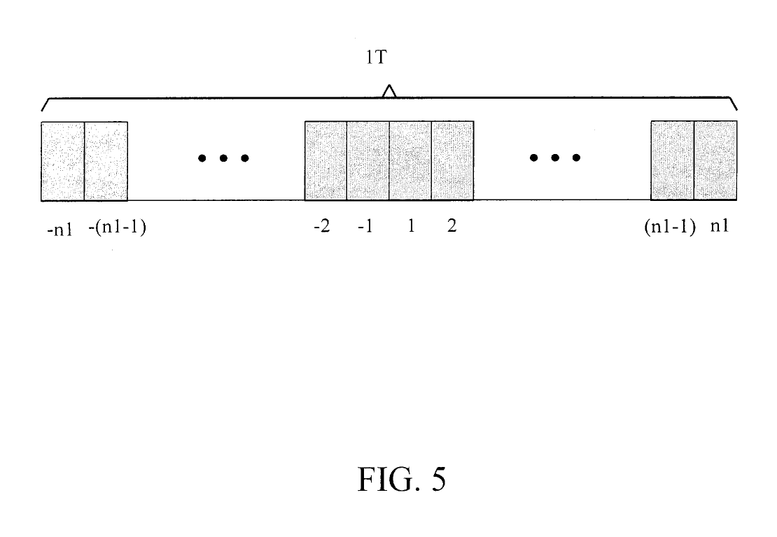

FIG. 5 is an explanatory view of data storage method for writing signal xₖ in each time section according to the invention. A time unit period is divided into 2ⁿ^{ₗ} sections labeled −nₗ, −(nₗ−1), . . . , −2, −1, 1, 2, . . . , nₗ. Let 0≦S(xₖ+O)≦nₗ in which S is a ratio parameter; and O is an offset. This makes the pulse width modulation.

Using solely a pulse width modulation or a pulse amplitude modulation is hard to achieve high resolution. The invention thus applies both pulse width modulation (PWM) and pulse amplitude modulation (PAM) for the writing signals. The PWM provides an integer portion that is an integer section width. The PAM provides a decimal portion that the modulation falls within a section width, and the amplitude is divided into nₖ units.

The relationship between the writing signal and the modulation is that the number of time sections for a pulse width modulation is 2w, and w=floor(S(xₖ+O))

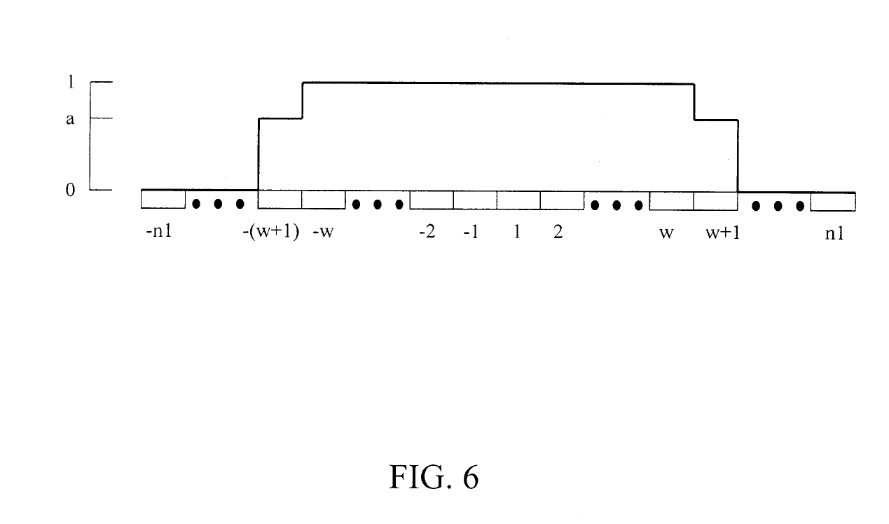

An example of writing signals through PWM and PAM is illustrated in FIG. 6. 2w numbers of sections between section −w and section w have amplitude of 1. Two sections labeled −(w+1) and (w+1) have amplitude of “a” where

$$a = \frac{1}{{n}_{h}} round ( {n}_{h} ( S ( {x}_{k} + O ) - w ) ) .$$

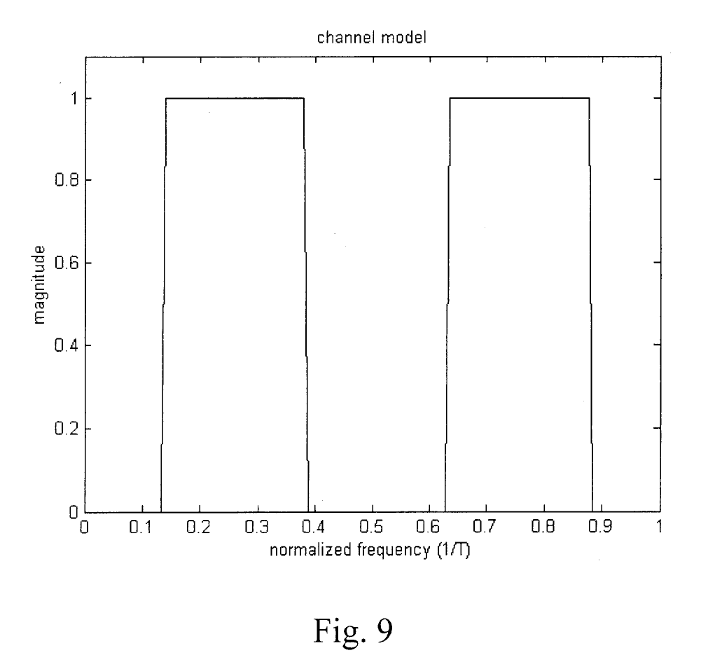

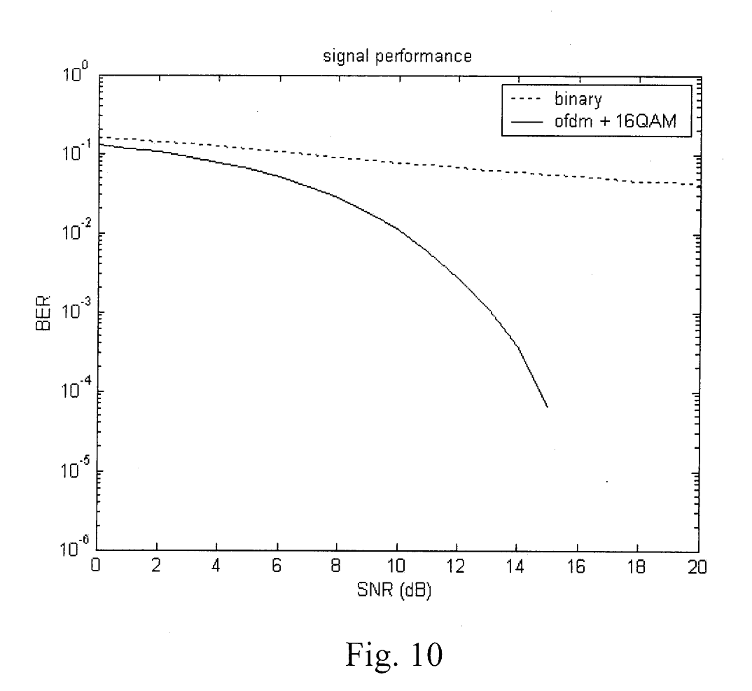

The following simulation can explain the advantages of the invention that uses orthogonal frequency division multiplexing. Supposing under a same data transfer rate, a storage channel frequency response is shown in FIG. 9, which is an ideal bandpass model that only a half of frequency band signals pass through and the other half is vanished after the channel. Based on this channel, data are only arranged on those frequency bands having response magnitude of 1, and none on the bands of magnitude 0. Since only a half band can be used and finally real numbers of records have to be generated, we use qudrature amplitude modulation (16QAM) and orthogonal frequency division multiplexing (OFDM) to modulate the data. FIG. 10 is a signal performance diagram of data storage through OFDM of the invention and comparing to conventional binary recording. From the diagram we can notice that at SNR of 15 dB, using ideal synchronous picking and without using equalizer, the difference of bit error rate between the two is almost 10³ times. That is the performance that the method of the invention can obtain.

In conclusion, the invention provides a new method utilizing orthogonal frequency division multiplexing to improve channel efficiency and to increase data storage capacity of an optical storage medium. The orthogonal frequency division multiplexing arranges data in a frequency domain. In order to prevent the retrieved signal in time domain from being a complex number, the data are arranged in the frequency domain in a conjugated and symmetric manner. The time domain signals are of multiple levels that cannot be handled with conventional binary recording. Therefore, the invention applies a compositive modulation of pulse width and pulse amplitude for the writing signals.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data recording method of optical storage medium, comprising steps of:
dividing a storage channel into multiple sub-channels;
determining recordable bits of said multiple sub-channels according to signal to noise ratio of said storage channel; and
transforming an input signal to be recorded on said optical storage medium from frequency domain to time-domain, and recording said time-domain signal on said optical storage medium.

2. The data recording method of optical storage medium according to claim 1, wherein said frequency-domain signal is conjugatedly symmetric.

3. The data recording method of optical storage medium according to claim 1, wherein said time-domain signal is recorded on said medium through a compositive modulation of pulse width and pulse amplitude.

4. The data recording method of optical storage medium according to claim 1, wherein said step of transforming an input signal to be recorded on said optical storage medium from frequency domain to time-domain further comprises a step of copying a rear wave portion of a signal frame to get a prefix and inserting to front portion of a next frame.

5. The data recording method of optical storage medium according to claim 1, wherein said step of transforming an input signal to be recorded on said optical storage medium from frequency domain to time-domain is operated with inverse discrete Fourier transform.

6. The data recording method of optical storage medium according to claim 1, wherein said signal to noise ratio of said storage channel is
$$SNR = \frac{{\vert DFT ( h ) \vert}^{2} {S}_{X}}{{S}_{TN}}$$
wherein S_{H}=|DFT(h)|² is a power transfer function of said storage channel; S_{TN} is a power spectrum of total noise; and S_{X}=|X|² is a power spectrum of said input signal.

7. A data recording method of optical storage medium, comprising steps of:
dividing a storage channel into multiple sub-channels;
determining recordable bits of said multiple sub-channels according to signal to noise ratio of said storage channel;
transforming an input signal to be recorded on said optical storage medium from frequency domain to time-domain; said input signal is conjugatedly symmetric; and
recording said time-domain signal on said optical storage medium through a compositive modulation of pulse width and pulse amplitude.

8. The data recording method of optical storage medium according to claim 7, wherein said step of transforming an input signal to be recorded on said optical storage medium from frequency domain to time-domain further comprises a step of copying a rear wave portion of a signal frame to get a prefix and inserting to front portion of a next frame.

9. The data recording method of optical storage medium according to claim 7, wherein said step of transforming an input signal to be recorded on said optical storage medium from frequency domain to time-domain is operated with inverse discrete Fourier transform.

10. The data recording method of optical storage medium according to claim 7, wherein said signal to noise ratio of said storage channel is
$$SNR = \frac{{\vert DFT ( h ) \vert}^{2} {S}_{X}}{{S}_{TN}}$$
wherein S_{H}=|DFT(h)|² is a power transfer function of said storage channel; S_{IN} is a power spectrum of total noise; and S_{X}=|X|² is a power spectrum of said input signal.
